(19) United States
(12) Patent Application Publication
(10) Pub. No.: US 2008/0181178 A1
(43) Pub. Date: Jul. 31, 2008

(54) METHOD AND APPARATUS FOR PERFORMING ATTACHMENT PROCEDURES

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/017,431

(22) Filed: Jan. 22, 2008

Related U.S. Application Data
(60) Provisional application No. 60/887,368, filed on Jan. 31, 2007.

(51) Int. Cl. H04Q 7/00

(52) U.S. Cl. 370/331

(57) ABSTRACT

A method and apparatus for implementing an attachment procedure in multi-mode systems are disclosed. A wireless communication system includes at least one of a second generation (2G) system, a third generation (3G) system, a long term evolution (LTE) and system architecture evolution (SAE) of the 3G system and a non-3G system. For performing an attachment procedure, a wireless transmit/receive unit (WTRU) sends an attach request message to a new serving general packet radio service (GPRS) support node (SGSN) indicating an attach type. The new SGSN and the WTRU then perform an attachment procedure based on the attach type. The attach type may indicate a GPRS only attachment, a GPRS and SAE attachment, or a 3GPP and non-3GPP attachment.

### CROSS REFERENCE TO RELATED APPLICATIONS

This application claims the benefit of U.S. Provisional Application No. 60/887,368 filed Jan. 31, 2007, which is incorporated by reference as if fully set forth.

### FIELD OF INVENTION

This application is related to wireless communications.

### BACKGROUND

Long term evolution (LTE) and system architecture evolution (SAE) of a third generation (3G) wireless communication system are being developed to provide higher data rates, lower latency, and support of multiple radio access technologies (RATs). The main features of the LTE include an enhanced air interface to handle higher data rates with more efficiency, optimization of conventional procedures to reduce the number of signaling procedures and reduce setup delay, and network design to permit interconnection and interoperation of any air interface, such as global system for mobile communications (GSM), general packet radio service (GPRS), wideband code division multiple access (WCDMA), code division multiple access 2000 (CDMA 2000), IEEE 802.xx, and the like.

### SUMMARY

A method and apparatus for performing attachment procedures are disclosed. The attachment procedures are performed in a multi-mode wireless communication system including at least one of a second generation (2G) system, a 3G system, an LTE and SAE of the 3G system and a non-3G system. A wireless transmit/receive unit (WTRU) sends an attach request message to a new serving GPRS support node (SGSN) indicating an attach type. The new SGSN and the WTRU then perform an attachment procedure based on the attach type. The attach type may indicate a GPRS only attachment, a GPRS and SAE attachment, or third generation partnership project (3GPP) and non-3GPP attachment.

The new architecture disclosed herein allows for multiple mobility management for a data session at the core network and the interworking between a 3GPP network and other networks, (e.g., CDMA 2000, worldwide interoperability for microwave access (WiMAX), and the like).

### BRIEF DESCRIPTION OF THE DRAWINGS

A more detailed understanding may be had from the following description, given by way of example in conjunction with the accompanying drawings wherein:

FIG. 1 is a signaling diagram of a simplified attachment procedure;

FIGS. 2A-2D, taken together, are a signaling diagram of an attachment procedure implemented during a handover;

FIG. 3 is a block diagram of a WTRU used to perform the attachment procedures of FIGS. 2A-2D;

FIG. 4 is a block diagram of an SGSN/mobility management entity (MME) used to perform the attachment procedures of FIGS. 2A-2D;

FIG. 5 is a block diagram of a gateway GPRS support node (GGSN)/3G access gateway (aGW) used to perform the attachment procedures of FIGS. 2A-2D; and

FIG. 6 is a block diagram of an SAE aGW used to perform the attachment procedures of FIGS. 2A-2D.

### DETAILED DESCRIPTION

When referred to hereafter, the terminology “WTRU” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

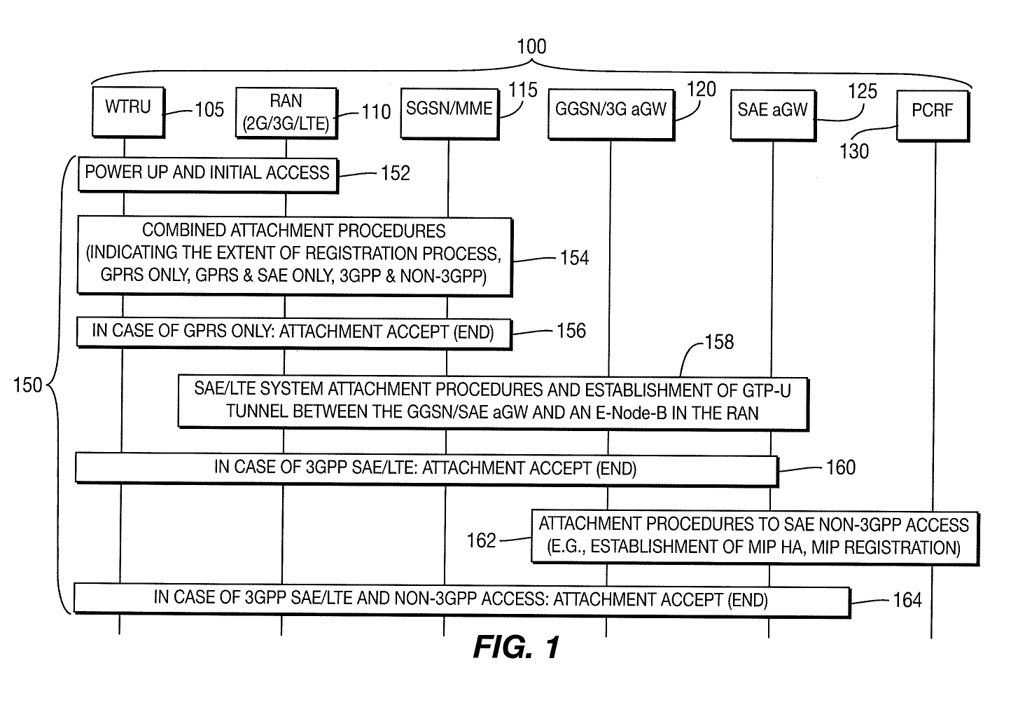

FIG. 1 is a signaling diagram of a simplified attachment procedure 150 implemented in a wireless communication system 100 including a WTRU 105, a radio access network (RAN) 110, a SGSN/MME 115, a GGSN/3G aGW 120, an SAE aGW 125 and a policy and charging rules function (PCRF) unit 130. Upon power up, the WTRU 105 establishes an initial access to an evolved Node-B (eNB) in the RAN 110, (i.e., 2G, 3G or LTE RAN) (step 152). The WTRU 105, the RAN 110 and the SSGN/MME 115 perform combined attachment procedures (step 154). For the various combined attachment procedures presented in FIG. 1, the extent of registration process, (i.e., GPRS only, GPRS and LTE/SAE only, and 3GPP and non-3GPP), is indicated.

The SGSN/MME 115 is configured to determine the type of registration by examining an information element (IE) included in the attach request message received from the WTRU 105. A legacy message format will identify the “GPRS only” registration. An SAE registration will be marked by the IE indicating the capability of the WTRU 105 as an SAE WTRU or an LTE WTRU. In the case of non-3GPP support, the WTRU 105 will indicate the type of mobility management required to support non-3GPP systems, (i.e., GPRS tunneling protocol (GTP) or mobile Internet protocol (MIP)). For MIP, the WTRU 105 indicates whether MIPv4, proxy MIP, or MIPv6 is being implemented. This may be either conveyed by indicating the IP version that is supported. For MIPv6, the WTRU 105 will indicate dual stack IPv6 support. In case of IPv4, the network may be configured to support proxy MIP.

In case of GPRS only, in response to an initial attach, the SGSN/MME 115 will send an attachment accept message (without the allocated IP address) to the WTRU 105. In case of the SAE, the GGSN/3G aGW 120 will send the attachment accept message to the SGSN/MME 115, which will forward it to the WTRU 105. This attachment accept message will include the IP address and the type of IP protocol (v4 or v6). In case of SAE and non-3GPP, the attachment accept message will indicate the successful home agent (HA) registration process so that the MIP client in the WTRU 105 is initiated. This is in response to the initial attach request message sent by the WTRU 105, which indicates which mobility management it supports for interworking with non-3GPP systems, (i.e., 3GPP GTP, MIP (v4, v6).

If the registration is for GPRS only, the attachment procedure is performed between the WTRU 105 and the SGSN/MME 115. Once attachment is established, an attachment accept message is sent (step 156).

If the registration is for 3GPP SAE/LTE, a GTP-U tunnel is established between a GPRS gateway support node (GGSN)/3G access gateway (aGW) and an eNB of the RAN (step 158). Once an attachment is established, an attachment accept message is sent (step 160).

If the registration is for 3GPP SAE/LTE and non-3GPP access, the attachment procedure for the SAE non-3GPP and policy and charging rules function (PCRF) is performed at step 162, (e.g., for establishment of mobile Internet protocol (MIP) home agent (HA), MIP registration, or the like). Once attachment is established, an attachment accept message is sent at step 164.

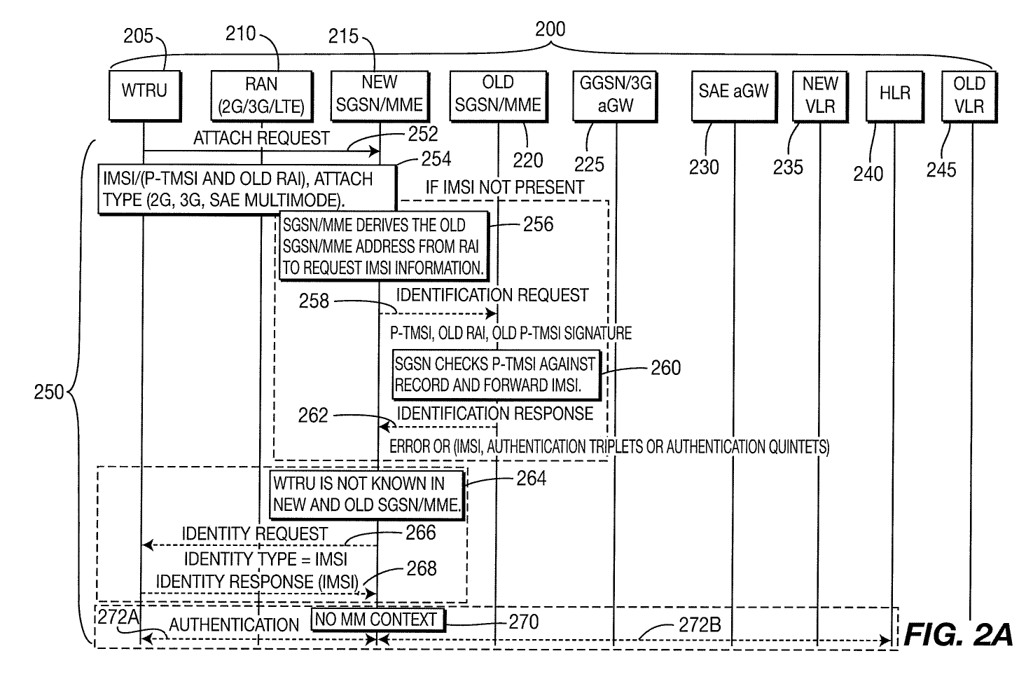

FIG. 2A is a signaling diagram of a simplified attachment procedure 250 implemented in a wireless communication system 200 including a WTRU 205, a RAN 210, a new SGSN/MME 215, an old SGSN/MME 220, a GGSN/3G aGW 225, an SAE aGW 230, a new visited location register (VLR) 235, a home location register (HLR) 240 and an old VLR 245. The WTRU 205 initiates the attach procedure by the transmission of an attach request message to the new SGSN/MME 215 (step 252). The attach request message includes an international mobile subscriber identity (IMSI), an attach type, or the like (step 254). Alternatively, instead of sending the IMSI, the attach request message may include a packet-temporary mobile subscriber identity (P-TMSI) and an old routing area identity (RAI). The attach type indicates the attachment type, such as 2G, 3G or SAE multimode attachment.

If the WTRU 205 identifies itself with the P-TMSI, the new SGSN/MME 215 derives an old SGSN address from the RAI to request IMSI information of the WTRU 205 (step 256). The new SGSN/MME 215 sends an identification request message to the old SGSN/MME 220 (step 258). The identification request message includes a P-TMSI, an old RAI, old P-TMSI signature, and the like. The old SGSN/MME 220 checks the P-TMSI against a record (step 260), and sends an identification response message with the IMSI of the WTRU 205 to the new SGSN/MME (step 262). If the WTRU 205 is known in the old SGSN/MME 220, the old SGSN/MME 220 responds with an identification response message including the IMSI, authentication triplets or authentication quintets in step 262. If the WTRU 205 is not known in the old SGSN/MME 220 or the old P-TMSI does not match the value stored in the old SGSN/MME 220, the old SGSN/MME 220 responds with an appropriate error indication in the identification response message at step 262.

If the WTRU 205 is unknown in the new SGSN/MME 215 and the old SGSN/MME 220 (step 264), the new SGSN/MME 215 sends an identity (ID) request (setting an ID type to IMSI) to the WTRU 205 (step 266). The WTRU 205 responds with an ID response including the IMSI of the WTRU 205 (step 268).

If no multi-mode (MM) context for the WTRU is evident (step 270), an authentication procedure is performed by the WTRU, the new SGSN/MME 215 and the HLR 240 (steps 272A and 272B).

Referring to FIG. 2B, an attachment procedure 350 for GPRS only is presented in further detail. Based on operator configuration (step 352), an international mobile equipment identity (IMEI) checking procedure may optionally be performed by the WTRU 205, the new SGSN/MME 215 and the GGSN/3G aGW 225 (steps 354A and 354B).

If the SGSN/MME number has changed since the last GPRS detach, or if it is the very first attach, the new SGSN/MME 215 updates the HLR 240 by sending an update location message to the HLR (steps 356 and 358). The update location message includes an SGSN/MME number, SGSN/MME address, the IMSI, and the like.

The HLR 240 compares the SGSN/MME number with records and sends a cancel location message (including IMSI and/or cancellation type) to the old SGSN/MME (steps 362 and 364). The old SGSN/MME 220 acknowledges with a cancel location acknowledgement (ACK) with IMSI (step 366). The HLR 240 then sends an insert subscriber data message to the new SGSN/MME 215 (step 368). The insert subscriber data message includes the IMSI, GPRS/SAE subscription data, packet data protocol (PDP) type, PDP address, access point name (APN), quality of service (QoS), virtual public land mobile network (VPLMN) allowed, and a multi-system registration accepted or rejected indication.

The new SGSN/MME 215 checks if the WTRU 205 is not allowed in the new routing area (RA) (step 370). If due to regional subscription restrictions or access restrictions the WTRU is not allowed to attach in the RA, the new SGSN/MME 215 rejects the attach request with an appropriate cause, and may return an insert subscriber data acknowledgement (ACK) (including the IMSI and/or an SGSN area restricted message) to the HLR 240 (step 372). If the subscription checking fails for other reasons, the new SGSN/MME also rejects the attach request with an appropriate cause and returns an insert subscriber data ACK (including the IMSI and/or an SGSN area restricted message) to the HLR (step 372). If all checks are successful, the new SGSN/MME 215 constructs an MM context for the WTRU 205 (step 374) and returns an insert subscriber data ACK (including the IMSI) to the HLR 240 (step 376). The HLR 240 then updates the MM context (step 378) and sends an update location ACK to the new SGSN/MME 215 (step 380).

Referring to FIG. 2C, an attach procedure 450 for a GPRS with IMSI attach type is presented in greater detail. If the attach type indicated in the attach request indicates a combined GPRS/IMSI attach, the new VLR 235 should be updated. The new SGSN/MME 215 sends a location update request to the new VLR 235 (step 452). The location update request includes a new LAI, the IMSI, an SGSN number, a location update type and the like.

The new VLR 235 creates an association with the new SGSN/MME 215 by storing the SGSN number. If the location update is inter-mobile switching center (MSC), the new VLR 235 sends an update location message (including the IMSI and a new VLR address) to the HLR 240 (step 454). The HLR 240 then sends a cancel location message to an old VLR 245 (step 456). The old VLR 245 acknowledges with a cancel location ACK (step 458). The HLR 240 sends an insert subscriber data message (including the IMSI and/or subscriber data) to the new VLR 235 (step 460). The new VLR 235 acknowledges with an insert subscriber data ACK with IMSI (step 462). After finishing the inter-MSC location update procedures, the HLR 240 responds with an update location ACK to the new VLR 235 with the IMSI (step 464). The new VLR 235 responds with a location update accept message (including VLR TMSI) to the new SGSN/MME 215 (step 466).

A second attach type is also shown in FIG. 2C, which is an SAE/non-3GPP with IMSI attach procedure. In step 468, the new SGSN/MME 215 sends a create PDP context request message to the GGSN/3G aGW 225. The GGSN/3G aGW 225 responds with a create PDP context response message to the new SGSN/MME 215 (step 470). The new SGSN/MME 215 sends a message for establishing a tunnel to the GGSN/3G aGW (step 472) and a radio access bearer (RAB) to the RAN (step 474). An RAB then is established between the WTRU 205 and the RAN 210, and the RAN 210 sends a tunnel establishment and RAB setup ACK to the new SGSN/MME 215 (step 476) after a GTP-U tunnel is established between the RAN and the GGSN/3G aGW (step 478).

Referring to FIG. 2D, an attach procedure 550 for an SAE with IMSI attach type is presented. The GGSN/3G aGW 225 recognizes the multimode registration and invokes non-3GPP registration and mobility protocol (step 552). The GGSN/3G aGW 225 sends a non-3GPP attach request message to an SAE aGW (step 554). The SAE aGW 230 establishes a session state for the WTRU 205 and inter system mobility registration, (e.g., MIP), (step 556). A QoS profile is then downloaded from a policy and charging rule function (PCRF) unit 250 (step 558). The SAE aGW 230 sends a non-3GPP attach accept message to the GGSN/3G aGW 225 (step 560). The GGSN/3G aGW 230 sends a 3GPP-based and non-3GPP-based attach accept message to the new SGSN/MME 215 (step 562).

The new SGSN/MME 215 forwards the attach accept message to the WTRU 205 indicating success or failure of the 3GPP and non-3GPP attachment (step 564). The WTRU 205 then sends an attach complete message to the new SGSN/MME (step 266).

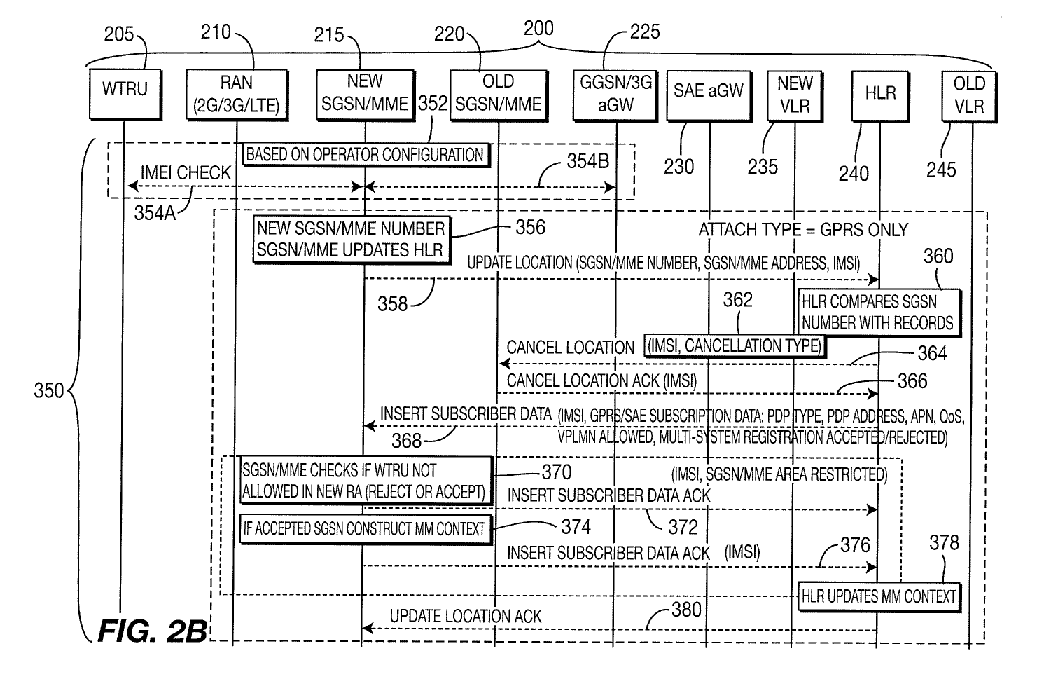

FIG. 3 is a block diagram of a WTRU 300 configured to implement the attachment procedures of FIGS. 2A-2D. The WTRU 300 includes a transmitter 305, a receiver 310, a processor 315 and an antenna 320.

The processor 315 is configured to generate at least one IE that indicates at least one of the capability of the WTRU and the type of mobility management required to support the WTRU in a non-3GPP system. The IE may indicate that the WTRU is SAE capable or LTE capable. The IE may indicate that GTP or MIP mobility management or is required to support the WTRU in a non-3GPP system. For MIP mobility management, the IE may further indicate whether MIPv4, proxy MIP or MIPv6 mobility management is required. The attach request message may include an IMSI and an attach type indicator. The attach type indicator may indicate a 2G multimode attachment, a 3G multimode attachment or an SAE multimode attachment.

The transmitter 305 is configured to transmit an attach request message including the at least one IE and an IMSI. Alternatively, the transmitter 305 may be configured to transmit an attach request message including a P-TMSI, an old RAI and an attach type indicator. The receiver 310 is configured to receive an attach accept message and an identity request message.

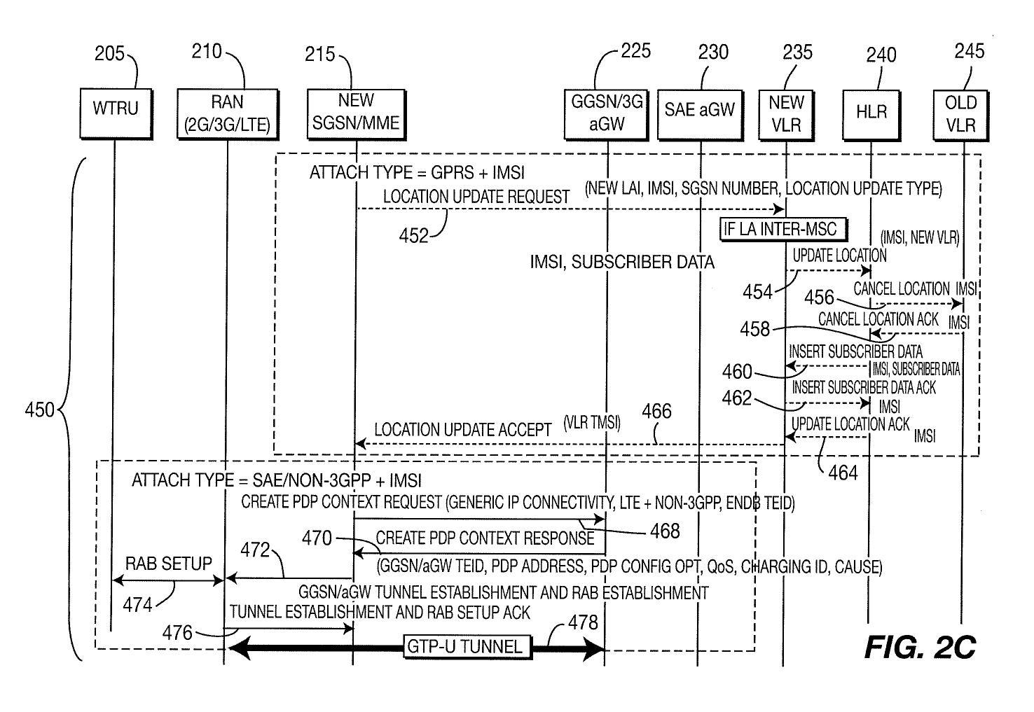

FIG. 4 is a block diagram of an SGSN/MME 400 configured to implement the attachment procedures of FIGS. 2A-2D. The SGSN/MME 400 includes a transmitter 405, a receiver 410, a processor 415 and an antenna 420. The receiver 410 is configured to receive an attach request message including at least one of an attach type indicator and preferred mobility management information. The processor 415 is configured to determine an extent of a registration process based on the attach type indicator. The extent of the registration process may be GPRS only, GPRS and SAE/LTE only, or 3GPP and non-3GPP.

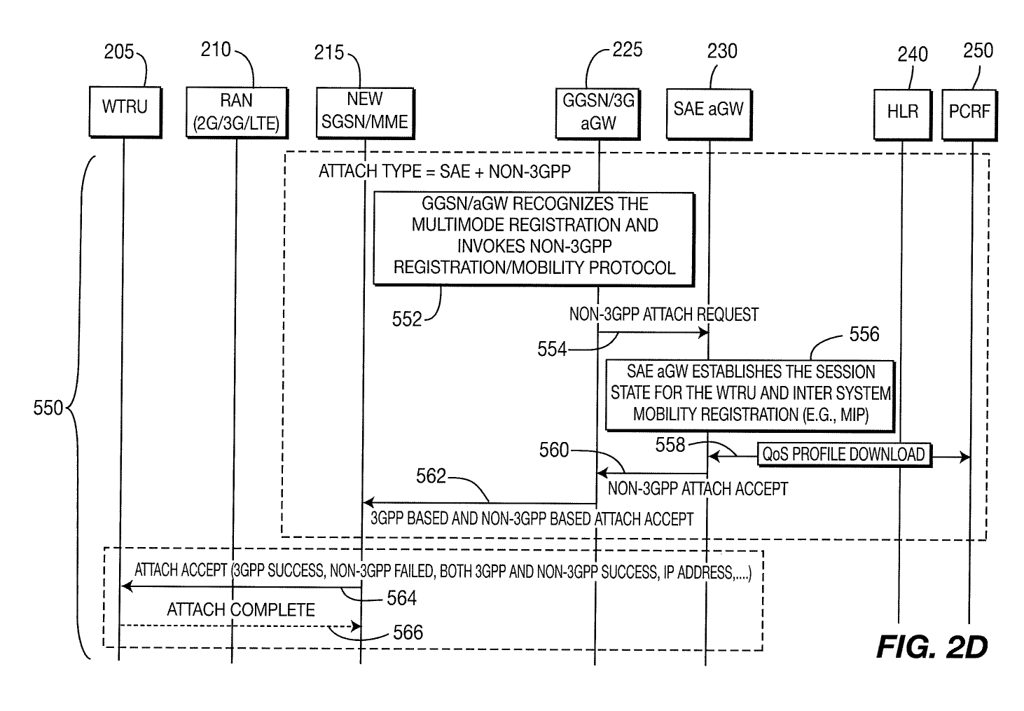

FIG. 5 is a block diagram of a GGSN/3G aGW 500 configured to implement the attachment procedures of FIGS. 2A-2D. The GGSN/3G aGW 500 includes a transmitter 505, a receiver 510, a processor 515 and an antenna 520. The processor 515 is configured to recognize a multimode registration and invoke non-3GPP registration/mobility protocol. The transmitter 505 is configured to transmit a non-3GPP attach request message. The receiver 510 is configured to receive a non-3GPP attach accept message in response to the non-3GPP attach request message.

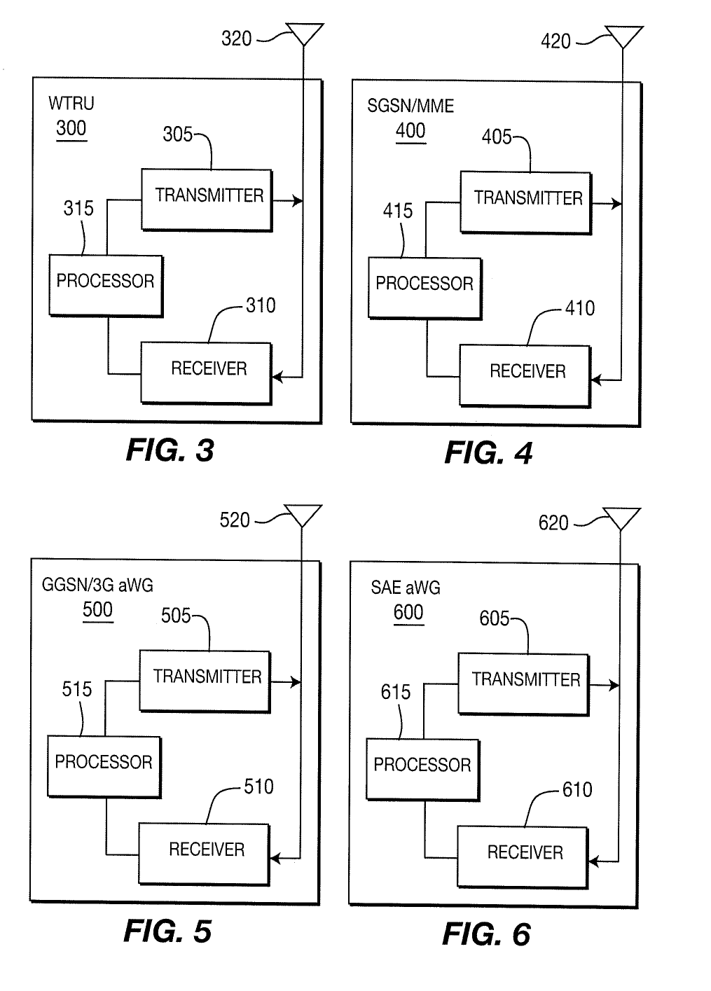

FIG. 6 is a block diagram of an SAE aGW 600 configured to implement the attachment procedures of FIGS. 2A-2D. The SAE aGW 600 includes a transmitter 605, a receiver 610, a processor 615 and an antenna 620. The receiver 610 is configured to receive a non-3GPP attach request message and a quality of service (QoS) profile. The processor 615 is configured to establish a session state for a WTRU and inter-system mobility registration. The transmitter 605 is configured to transmit a non-3GPP attach accept message to indicate that the inter-system mobility registration has been completed. The inter-system mobility registration may be a MIP registration.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A wireless transmit/receive unit (WTRU) comprising:
a processor configured to generate at least one information element (IE) that indicates at least one of the capability of the WTRU and the type of mobility management required to support the WTRU in a non-third generation partnership project (3GPP) system;
a transmitter configured to transmit an attach request message including the at least one IE; and
a receiver configured to receive an attach accept message.

2. The WTRU of claim 1 wherein the IE indicates that the WTRU is system architecture evolution (SAE) capable.

3. The WTRU of claim 1 wherein the IE indicates that the WTRU is long term evolution (LTE) capable.

4. The WTRU of claim 1 wherein the IE indicates that general packet radio service (GPRS) tunneling protocol (GTP) mobility management is required to support the WTRU in a non-3GPP system.

5. The WTRU of claim 1 wherein the IE indicates that mobile Internet protocol (MIP) mobility management is required to support the WTRU in a non-3GPP system.

6. The WTRU of claim 5 wherein the IE indicates whether MIPv4, proxy MIP or MIPv6 mobility management is required.

7. The WTRU of claim 1 wherein the attach request message includes an international mobile subscriber identity (IMSI).

8. The WTRU of claim 1 wherein the attach request message includes a packet-temporary mobile subscriber identity (P-TMSI) and an old routing area identity (RAI).

9. The WTRU of claim 1 wherein the attach request message includes a request for a second generation (2G) multimode attachment.

10. The WTRU of claim 1 wherein the attach request message includes a request for a third generation (3G) multimode attachment.

11. The WTRU of claim 1 wherein the attach request message includes a request for a system architecture evolution (SAE) multimode attachment.

12. A serving general packet radio service (GPRS) support node (SGSN)/mobility management entity (MME) comprising:
a receiver configured to receive an attach request message including at least one information element (IE) that indicates at least one of the capability of the WTRU and the type of mobility management required to support the WTRU in a non-third generation partnership project (3GPP) system;
a processor configured to determine an extent of a registration process based on the at least one of the IE and the mobility management type; and
a transmitter configured to transmit instruction messages for performing an attachment procedure associated with the WTRU in accordance with at least one of the capability of the WTRU and the type of mobility management required to support the WTRU.

13. The SGSN/MME of claim 12 wherein the extent of the registration process is GPRS only.

14. The SGSN/MME of claim 12 wherein the extent of the registration process is GPRS and system architecture evolution (SAE)/long term evolution (LTE) only.

15. The SGSN/MME of claim 12 wherein the extent of the registration process is third generation partnership project (3GPP) and non-3GPP.

16. A wireless transmit/receive unit (WTRU) comprising:
a receiver configured to receive an identity request message;
a processor configured to generate an identity response message, and an attach request message including a packet-temporary mobile subscriber identity (P-TMSI), an old routing area identity (RAI) and an attach type indicator; and
a transmitter configured to transmit the identity response message and the attach request message.

17. The WTRU of claim 16 wherein attach type indicator indicates a second generation (2G) multimode attachment.

18. The WTRU of claim 16 wherein attach type indicator indicates a third generation (3G) multimode attachment.

19. The WTRU of claim 16 wherein attach type indicator indicates a system architecture evolution (SAE) multimode attachment.

20. A gateway general packet radio service (GPRS) support node (GGSN)/mobility management entity (MME) comprising:
a processor configured to recognize a multimode registration and invoke a non-third generation partnership project (3GPP) registration/mobility protocol;
a transmitter configured to transmit a non-3GPP attach request message; and
a receiver configured to receive a non-3GPP attach accept message.

21. A wireless transmit/receive unit (WTRU) comprising:
a receiver configured to receive an attach accept message indicating success or failure of a third generation partnership project (3GPP) and non-3GPP attachment; and
a transmitter configured to transmit an attach complete message indicating that the WTRU is ready for non-3GPP interworking mobility.

22. A system architecture evolution (SAE) access gateway (aGW) comprising:
a receiver configured to receive a non-third generation partnership project (3GPP) attach request message and a quality of service (QoS) profile;
a processor configured to establish a session state for a wireless transmit/receive unit (WTRU) and inter-system mobility registration; and
a transmitter configured to transmit a non-3GPP attach accept message to indicate that the inter-system mobility registration has been completed.

23. The SAE aGW of claim 22 wherein the inter-system mobility registration is a mobile Internet protocol (MIP) registration.
